(19) United States
(12) Patent Application Publication
(10) Pub. No.: US 2004/0173199 A1
(43) Pub. Date: Sep. 9, 2004

(54) Salaman grill

(75) Inventor: Dante Cantal, Yorba Linda, CA (US)

Correspondence Address: Michael Oleinik, McDermott, Will & Emery, 2049 Century Park East, 34th Floor, Los Angeles, CA, 90067, US

(73) Assignee: Twin Eagles, Inc.

(21) Appl. No.: 10/383,160

(22) Filed: Mar. 5, 2003

(51) Int. Cl. A47J 37/00; F24C 3/00

(52) U.S. Cl. 126/41 R; 126/39 E

(57) ABSTRACT

A novel grill with a heat source mounted above the cooking rack and a cooking cavity for the retention of heat and for protection from the user. The cooking cavity contains a door for access to the interior of the cavity. A window may be situated on the door or a side wall for viewing the cooked items. In certain embodiments, a seating mechanism resides in the cooking cavity for accommodating a rack upon which food is placed and enabling the rack to reside on various levels. In another embodiment, the top wall of the burner is angled to maintain intense heat within the burner and away from the user. A control cavity in another embodiment may be used to house control mechanisms, such as batteries to power the igniter and a valve to control the gas pressure.

### BACKGROUND

### FIELD

The present invention relates generally to grilling systems, and particularly to a novel grill for cooking food efficiently, effectively, and safely, and for maintaining optimal flavor.

### BACKGROUND

Traditional outdoor grills are configured with heat sources residing below the cooking area. One example is a simple charcoal grill. Such a grill contains a cavity in which charcoal is placed and ignited. This grill also contains a grate situated above the charcoal onto which the food is placed. A disadvantage of the charcoal grill is that food drippings generated from the cooking process fall into the cavity and ignite. The ignition of these drippings causes unwanted flames or flare ups to flow through the grate. These flames can scorch the food. Worse, the unwanted flames can pose a safety hazard to persons near the grill. Another example is a gas grill, where the charcoal is replaced by gas burners. Here, flare-ups from food drippings still present problems.

In many types of grills, including the charcoal and gas grill discussed above, the positioning of the cooking mechanism below the food creates other problems. Drippings and other by-products of the cooking process create a mess inside the cavity of these grills. For grills that use another type of burner such as an infrared burner, the drippings can clog the infrared device, requiring extensive and periodic cleaning. If left unchecked, the clogging can dramatically change the flame characteristics of the burner, producing undesirable emissions, unwanted temperatures or uneven hot spots. Eventually, the repeated flow of unwanted by-products onto the burner can result in permanent failure and the need for replacement.

Still other outdoor grills offer a rotisserie option, where the food is turned on a rotating spit. In one such system, an infrared burner is mounted vertically above the grilling surface and behind the food content. This arrangement results in the infrared flame being exposed forward toward the direction of the user. Hence, the burner releases high temperature and flue products towards the user. Obviously, this state of affairs can be highly undesirable. In a situation where the ignition is unpredictably delayed or the resulting flame is large in magnitude, the flame will move directly toward the unsuspecting user. Such a condition can produce a fire hazard and may even result in injury.

Moreover, in a traditional grill arrangement, the heat source generates juice originating predominantly from the bottom of the food content, where the heat source is closest. Gravity causes the juice to escape the food and drip into the cavity below. This arrangement can dry the food and deprive it of otherwise flavor-enhancing juices. Likewise, in a traditional rotisserie arrangement with the heat source located vertically behind the food content and rotating on a spit, the juice from the food will drip down below the rotating food and produce the same undesirable result.

### SUMMARY

In one aspect of the present invention, a grill including a cooking cavity including a top wall, side walls and a bottom floor, one of the side walls including an access door, the top wall including a radiant heat source for emitting radiant heat downward toward the bottom floor, a rack configured for placement in the cooking cavity, and an igniter configured to provide ignition for the radiant heat source.

In another aspect of the invention, a grill includes cavity means for placing a food on a rack supported by a seating means in the cavity, the cavity means further including access means for inserting and removing food within the cavity, the access means configured to allow access to the cavity, and means for providing radiant energy for emission downward toward the rack for cooking the food item.

In yet another aspect of the invention, a grill includes a cavity including an enclosure, the enclosure including side walls, each side wall including two side edges, each side edge coupled to another side edge to form the enclosure, one side wall including an access door, and each of the side walls including a top edge and a bottom edge, a top wall coupled to the top edges of the enclosure, and a bottom wall coupled to the bottom edges of the enclosure, wherein the top wall includes an infrared burner including a combustible surface configured to emit heat downward towards the floor, a rack configured for placement in the cavity, and an igniter configured to provide ignition for the radiant heat source.

Other embodiments of the present invention will become readily apparent to those skilled in the art from the following detailed description, wherein it is shown and described only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is a drawing of an embodiment of the grill displaying the cooking cavity and with the rack extended.

FIG. 2 is a drawing of an embodiment of the grill showing the control cavity and burner.

FIG. 3 is a drawing of a front view of an embodiment of the grill, minus the burner cover and portions of the door.

FIG. 4 is a drawing of a close-up view of an embodiment of the venturi and burner inlet.

FIG. 5 is a side view of an embodiment of the grill showing a pulled out dripping pan and a seating mechanism for supporting the rack.

FIG. 6 is a rear view of an embodiment of the grill 10 showing portions of the top panel and the control cavity.

FIG. 7 is an angled view of an embodiment of the grill configured as part of an island with a side wall cut away to show the cooking cavity.

FIG. 8 is an alternative embodiment of a stand-alone grill with a side wall cut away.

### DETAILED DESCRIPTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form in order to avoid obscuring the concepts of the present invention. Acronyms and other descriptive terminology may be used merely for convenience and clarity and are not intended to limit the scope of the invention. In addition, for the purposes of this disclosure, the term “coupled” means “connected to” and such connection can either be direct or, where appropriate in the context, can be indirect, e.g., through intervening or intermediary devices or other means.

A grill is disclosed in which the heat source is mounted above the rack for holding the food content. The heat source generates radiant heat to broil the food. In one embodiment, the food is enclosed within a cooking cavity, with a front door available for food access. Moveable racks may be used to maintain desirable cooking temperatures. Food is broiled in one aspect through radiant heat generated by a gas infrared heat source.

Because the heat source is mounted above the food content, juice, grease, and other food drippings generated from the cooking process and collected below will not ignite easily. The occurrence of flare-ups associated with traditional grills, where the grease catches on fire and produces unpredictable flames, is largely eliminated. Moreover, the positioning of the heat source is above the cooking surface rather than below the food as in conventional outdoor residential grills. The position of the heat source above the food means that by-products from the cooking process will not clog the heat source. The positioning of the heat source also solves the potential hazards encountered in outdoor grill rotisseries where the burner is oriented in the direction of the user. Unlike those grills, the heat source is directed downward rather than towards the user, making the cooking mechanism safer for the user.

Mounting the infrared burner above the food content will generate juice on the top surface of the food. These juices remain within the food. They generally do not flow down and away from the food content. Thus, the present arrangement tends to “seal” the juice within the food content, enhancing the flavor and preserving the natural moisture within the food.

The embodiment in which multiple shelves (or multiple shelf inserts) and multiple shelf locations are used allows the user to adjust the cooking temperature by lowering and raising the food on the shelves, obviating the requirement in many cases that the user change the setting on the infrared burner. Traditional infrared burner mechanisms typically require that the user adjust the cooking temperature by changing the BTU setting. This step is often ineffective and produces unpredictable results. Most infrared burners do not perform optimally when adjusted below their designated BTU settings. Moreover, reducing the BTU setting of certain infrared burners below a threshold may well cause unstable flame characteristics, including flashback or extinction. By contrast, the present embodiments enable the user to downward adjust the level of radiant heat on the food by simply lowering the shelf or placing the food onto a lower shelf.

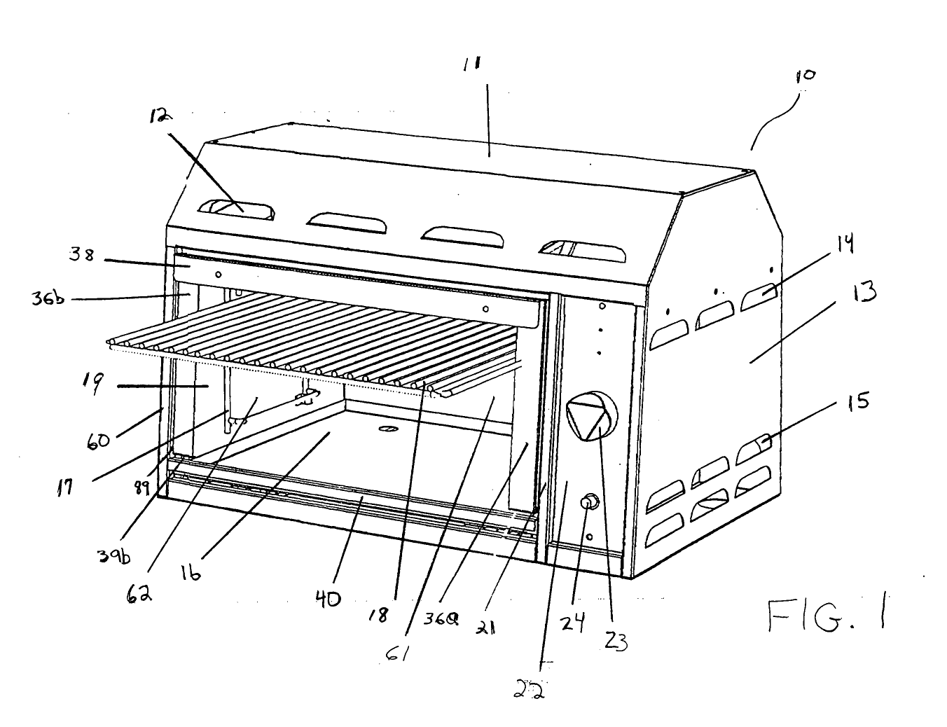

FIG. 1 depicts an illustration of an embodiment of the grill 10. To assist in better understanding the functionality of the grill 10, not all of the components are precisely drawn to scale. Also, for clarity and to avoid unduly obscuring the grill 10 in FIG. 1, certain components are omitted from the figure. The grill 10 in this embodiment includes a door panel with right and left door panel borders 36a and 36b, respectively. The door panel border 36b may be coupled to the corresponding hinge 39b. In this embodiment, the door panel borders 36a and 36b and the hinge 39b reside on the grill in the front for easy opening and access to the food items. The hinge 39b is employed so that the door can be opened by pulling down the door handle 38, in the same fashion as in a traditional residential oven. Multiple hinges may be used if desired.

In one embodiment, the door panel constitutes a window for observation purposes. The window may be glass having the thickness and structural composition appropriate for use with the hot grill 10. The glass of the window has sufficient gradient resistance so that the temperature difference between the cooking cavity 16 and an area outside the window is within some acceptable standard of tolerance. Alternatively, the window may constitute another transparent material provided that it meets or exceeds proper thresholds for withstanding the heat. The glass should contain sufficient thickness and insulation capability to maintain the heat at its exposed outer surface to within safety levels or otherwise within a suitable range to avoid dangerously high outer surface temperature levels. In yet another embodiment, a window is simply omitted; that is, the side panel that forms the opening of the grill 10 consists of in whole or in part an access panel for the food without a viewport. For clarity and ease of illustration, the window is omitted from the figure, exposing the cooking cavity 16 and the rack 18 extended outward and resting on a ledge in the cooking cavity 16.

In this figure, a cooking cavity 16 is formed in part by the front access panel wall and the three interior walls that form the inside of the grill 10 (all four of which are also considered side walls, as explained further below). The four side walls and the bottom floor form the lower portion of the cooking cavity 16. The bottom floor consists of the surface (not seen) below the cooking pan 40. The number of vertical side walls is usually determined by the number of sides of the grill 10. Thus, for example, in a four-sided grill such as grill 10 in FIG. 1, there are four vertical walls.

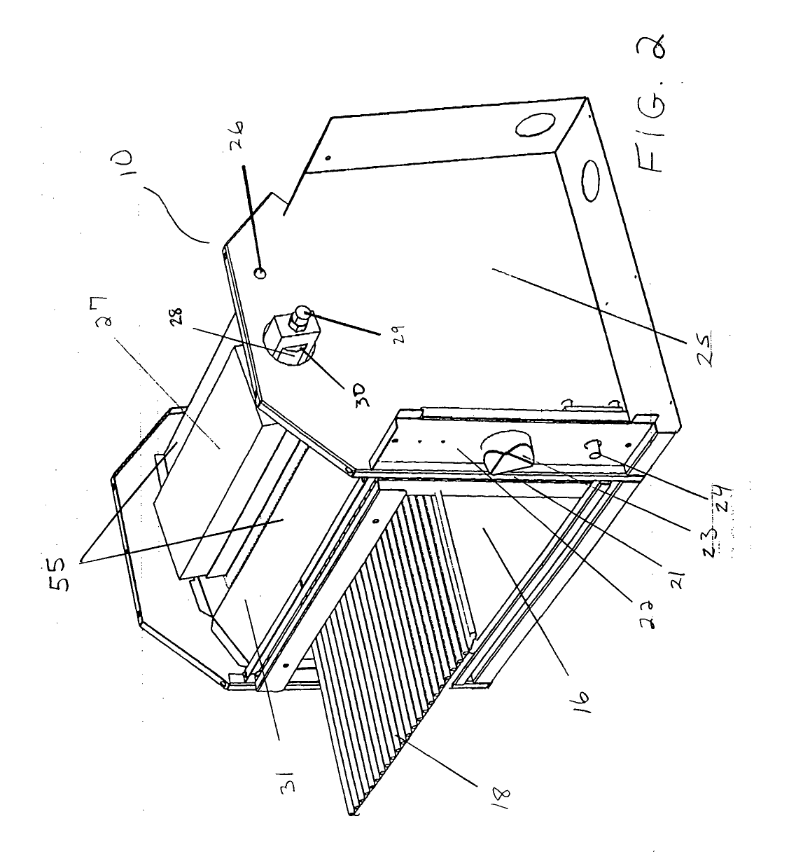

For purpose of this disclosure, a “side wall” is a substantially vertical (or in some embodiments it can include shapes or curves, etc. but is still ultimately situated in an up and down direction, and with two “side edges”) Two or more side walls can be coupled together at the side edges to form an enclosure which, when coupled with a bottom floor and an appropriately designed top wall (see FIG. 2), constitute a cooking cavity. As discussed in FIG. 1, three interior side walls and the front access door (partially not shown) form the four side walls used in that embodiment. Although obscured by burner cover 11, the top cover and integrated heat source, by virtue of its coupling to the top edges of the four side walls, form the cooking cavity 16.

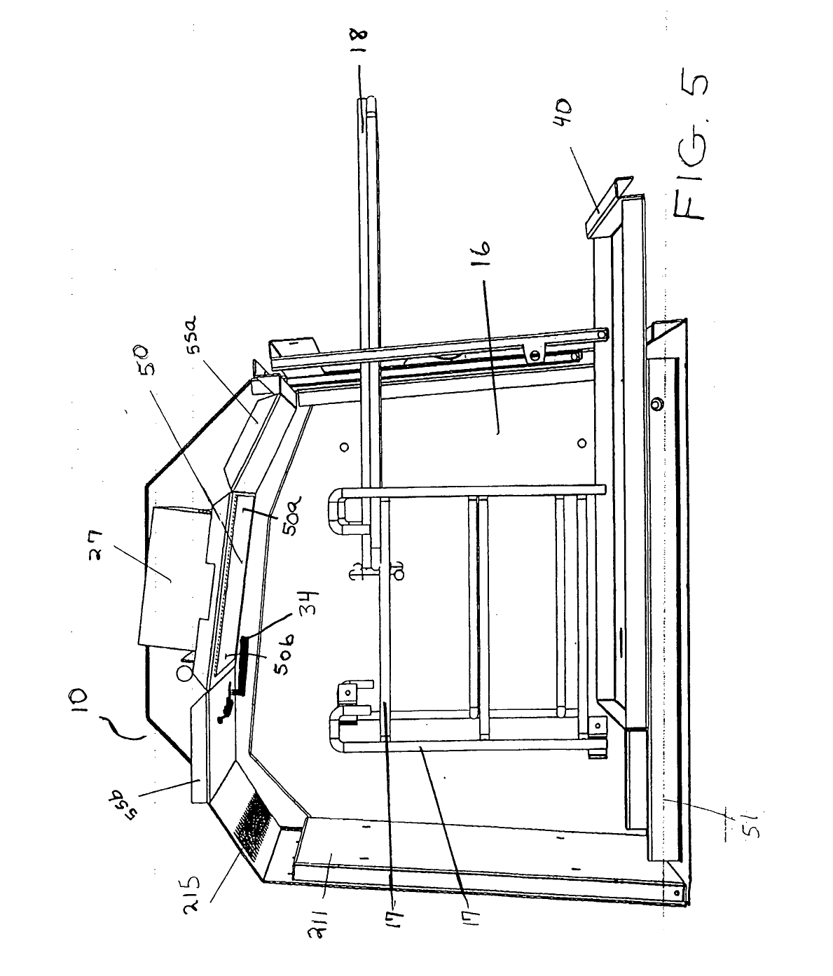

Depending on the embodiment, the side wall provides a role in or is used for, among other purposes: (i) to provide, together with the bottom surface (below the drip pan in FIG. 1) and top surface (see No. 31 in FIG. 2 and No. 50 in FIG. 5) a distinct cooking cavity dedicated specifically for radiant heat cooking, (ii) to define the interior volume, shape and size of the cooking cavity 16, (iii) to provide, in some embodiments, and potentially with other components, useful properties to the cooking cavity 16 desirable for radiant grills or that are appropriate for the embodiment (e.g., durability, certain heat reflection properties, dirt resistant surfaces, provision of vents, optimal reflection/absorbent properties to enhance cooking, etc.), (iv) to segregate the cooking cavity 16 from other areas in the grill or from the outside (including helping to separate the intense heat of the grill from areas outside the cavity, (v) to connect the side edges of each side wall to the corresponding edges of the side walls such that an enclosure is formed, (vi) to allow one of the side walls—usually (but not necessarily always) in the front of the grill 10—to provide access to and, in one embodiment, to provide a window in, that side wall. These considerations are but a few that may be considered in designing a grill such as in the embodiments of FIG. 1 or 2. While this list neither articulates the necessary requirements of the side walls nor sets forth the often intricate design considerations that can effect the cooking cavity design, it does provide insight into the potential flexibility and potential benefits of the cooking cavity 16. The precise design details that are ultimately chosen may, depending on the embodiment, produce a sophisticated and multi-faceted grill; however, the precise design details ultimately chosen and implemented are not essential components of the invention.

Depending on the design goals, the walls and floor can be constructed to define the volume and shape of the cooking cavity 16 to best suit the application. Factors that depend on the selected volume and shape (e.g., the heat density or requirements that maximize efficiency without significant performance sacrifices, etc.) may also be relevant. The top wall (seen, e.g., in numeral 31 in FIG. 2) likewise can play an important role such as, for example, selecting a heat source optimal for the volume and anticipated use of the grill, and selecting a top that includes angles to maintain the heat from the user (see the below embodiment), among others.

In more sophisticated systems, the cavity may be constructed with special bordering materials or may be designed with additional devices like fans inserted in the cavity. Such enhancements in many embodiments result in increased energy efficiency, better tasting food, increased heat transfer characteristics, improved heat distribution, etc.

For example, an electric or battery powered fan may be situated in the grill to move the hot air so that it spreads substantially evenly throughout the cavity, potentially resulting in more even cooked and tastier food. Certain materials in the cavity walls may themselves provide still further benefits, such as walls that maximize the retention of heat thereby enhancing efficiency, or walls that cause reflections of heat waves to expedite the cooking process or change the cooking characteristics. Choosing stronger cavity materials may add strength and durability to the grill, if so desired. Further, the inner walls assist (usually in conjunction with other walls and components in the grill) in separating the high temperatures in the cooking cavity from external sources. Accordingly, sensitive materials and circuitry outside the cooking cavity are less apt to overheat.

Obviously, the benefits of implementing a grill according to the embodiments herein are numerous. Substantial benefits and efficiencies, and decreased danger of burns due to heat that substantially remains within the cavity, as well as the cooking benefits of radiant heat that is confined to the cavity, thereby enabling the application of heat to the entire food item. These benefits stand in stark contrast to traditional grills without enclosures to maintain an evenly cooked food product and with potential fire or burn hazards, etc.

Referring briefly back to the FIG. 1 embodiment, as mentioned above, the side walls are coupled to each other to form a substantially sealed enclosure that is used in the cooking cavity 16. For the purposes of this disclosure, devices are broadly considered “coupled” if they are connected or attached, whether directly or indirectly through one or more intervening components, or if they are designed to fit together or make contact to perform a collective function even though not directly attached, subject only to condition that the proposed broad definition cannot be construed to produce absurd or nonsensical results.

The coupling mechanisms take many forms. Two walls, for example may be welded together at two edges, or they may be connected in one place via tiny screws. Both are usually considered examples of direct coupling. In other cases, the side wall coupling may be implemented through appropriate cements or welding techniques to the application. One of many examples of indirect coupling are two walls connected together by a third wall which is sealed, attached or otherwise affixed to the two walls (e.g., through welding and screws). Those walls are “coupled” together.

In some embodiments, side walls are supported by other components. These may include panels, divider walls insulation, traditional hardware components, insulators covers, vents etc. Panels may even overlay or the side wall to provide support or assist in temperature absorption. Side panels often exist in grill, some with vents for air circulation or temperature control. These components may provide a variety of functions, such as insulating the grill from heat, providing support for the side walls. Such components may be integral in various designs, providing support, durability, insulation, etc. Upon perusal of this disclosure, it will be apparent to one skilled in the art that such components can be deployed to facilitate grill operation in connection with the novel embodiments herein.

Returning to FIG. 1, as noted above, a first side panel is considered for purposes of this disclosure to include the front panel and access door (portions of which are door handle 38, walls 36a and 36b, and the window (omitted from this drawing)). A second side panel may include the wall 61, which forms in part a second wall of the cooking cavity 16. A third side panel may include, for example, the wall (not shown) on the left side of the grill. A fourth side panel includes the rear wall 61 of grill 100. Thus, the lower portion of the cooking cavity 16 in this embodiment is formed by the four side panels or walls (or wall sets) and a bottom floor, each side panel coupled on each of its two vertical sides to two corresponding vertical sides of the other side panels. In certain embodiments, however, separate components may be used to couple together the walls and may provide critical support to one or more side walls. In such embodiments, such components may constitute a portion of the cavity, since they are part of the mechanism that couples the walls together. As will be known in the art, these components may be included to provide certain desirable attributes of the grill. Each side panels also is coupled at its lower horizontal bottom edge to a side of the bottom floor. Also, while four side panels are used in the embodiment of FIG. 1, this number in other embodiments may be greater or less than four.

On the ceiling of the cooking cavity 16, an infrared burner (not seen in FIG. 1) resides in accordance with one embodiment, with its combustible media facing downward toward the cooking cavity 16. The angled burner cover 11 fits neatly over the burner 27 (see FIG. 2) in grill 10. The burner cover 11 helps protect the burner mechanism from exposure to foreign particles. The burner cover 11 also helps protect the user from accidental exposure to or contact with the heat.

High temperatures are generated by the underlying burner. Vents 12 allow air external to grill to cool the area inside the burner cover 11 and burner 27. (A total of four vents 12 exist on the front portion of the angled burner cover 11 and burner 27 in this embodiment). A control cavity side panel 13 contains a set of three vents (or louvers) 14 and another set of six vents 15 to allow the passage of air to and from a control cavity which is adjacent to the cooking cavity 16. Desired safety temperatures can be maintained by using the vents 12, 14 and 15. Vents on the opposite side wall (not shown) or on the rear wall may also be used to maintain the walls of grill 10 within safety requirements. In other embodiments, insulation may also be used to accomplish this goal.

The control cavity (25 in FIG. 2) resides directly behind the control panel 22 and to the right of dividing wall 21. A seating mechanism 17 resides on a side wall 19 of the cooking cavity 16. Another seating mechanism (not seen due to the orientation of the grill 10 in FIG. 1) resides on the opposite side wall. The purpose of the seating mechanism 17 in one embodiment is to provide sets of rigid metal wires to support a cooking rack 18. The seating mechanism 17 provides, in one embodiment, multiple bar sets to accommodate support for the cooking rack 18 at different vertical levels within the cooking cavity 16 relative to the burner mechanism. Different rack levels correspond to the exposure of the food to different levels of radiant heat.

Much like a conventional oven, the cooking rack 18 is designed to support a food item that will be cooked in the grill 10. By using the seating mechanism 17 to vary the position of the rack 18, the user can effectively control the temperature to which the food item will be exposed. For instance, if the user changes the rack 18 to sit on a lower level supported by the seating mechanism 17, the food will be exposed to a lower intensity of radiant heat and will cook slower and at a lower temperature. Conversely, as the user places the rack 18 on the upper supports of the seating mechanism 17, the food item will be closer to the heat source and the effective cooking temperature will increase. The appropriate level(s) for cooking the food item depends on a number of factors such as the type of food, the desired temperature, the user's culinary strategy for cooking the food item, the power level of the heat source, amount of grilling time, and others. A notable advantage of the seating mechanism 17 in FIG. 1 is that it provides a more precise and predictable method to control the cooking temperature than grills in which the user need resort to changing the gas pressure.

An orifice 2 may be used in some embodiments to drain the grease and other cooking by-products from the cooking cavity 16. Further, a drip pan 40 may reside in the bottom of the cooking cavity 16. Juice, grease, and any other dripping product generated by the cooking process may be collected. The drip pan 40 may be detachable from the grill 10 by pulling on the drip pan handle. The drip pan 40 may be cleaned on a periodic basis.

As noted above, to the right of the cooking cavity 16, a control cavity (see FIG. 2) exists in some embodiments. Though not explicitly depicted in this figure, the control cavity is behind the control panel 22. As such, the control panel is situated in this embodiment to the right of the cooking cavity 16. The control cavity may be separated from the cooking cavity 16 by a dividing wall 21. The dividing wall 21 protects the components contained within the control cavity from the heat and flue products generated in the cooking cavity 16. The control cavity in this embodiment is much smaller in volume than the cooking cavity 16. The control cavity is vented properly by vent sets 14 and 15 so that the operating temperature remains appropriate for the proper functioning of control components within the control cavity. Such control components may, for example, include a gas valve coupled to control knob 23 to regulate the amount of gas entering the burner, electrical components used for flame ignition, a manifold used to connect the gas valve to a gas source, etc. The control cavity may also contain elements such as a battery to power the igniter. The control cavity may also contain portions of the venturi. The venturi, as will be discussed, is a component of the burner that provides for the flow of gas and air into the burner enclosure to enable combustion. The venture includes an outlet that provides openings to accommodate the input of air and gas. Placing the outlet of the venturi in the control cavity avoids flue products and grease in the cooking cavity 16 from entering the venturi outlet, preventing an undesirable recirculation of emission. The control panel 22 associated with the control cavity contains a knob 23 which controls the gas pressure fed to the burner (see FIG. 2). The gas valve (not shown) referenced above and located in the control cavity is used to turn on the gas. The knob 23 further enables a user to control the pressure of the gas, and hence control the volume of the gas flow. The button 24 beneath the knob 23 in this embodiment is used for igniting the gas. In one embodiment, the button 24 is adjacent to a battery (not shown) located in the control cavity. The battery may be configured to provide a source of electrical power to the igniter. In other embodiments, a battery is not used. For instance, the igniter may be powered via a direct electrical connection to a wall socket. A piezo, rotary, or other type of igniter may also be implemented. Additionally, a hot surface type igniter may be implemented in lieu of a direct spark igniter. In still other instances, ignition may be manual, eliminating the need for electrical ignition circuitry.

In embodiments where gas is used to power the grill, the type of gas can vary. For instance, the grill 10 may be designed to accommodate natural gas, liquid propane (“LP”), and butane, among others.

FIG. 2 is an alternative view of an embodiment of the grill 10. The side panel 13 (FIG. 1) is removed so that the control cavity 25, separated from the cooking cavity 16 by the divider 21, may be seen. The burner cover 11 is also omitted from this illustration so that the configuration of the burner 27 according to an embodiment can be seen. The burner 27 will be discussed in greater length below. A venturi 28 can be shown, which allows the injection of air and gas to flow into the burner cavity as referenced below. While the venturi 28 is essential a part of the burner—and is so considered for purposes of this disclosure—the functionality of the venturi 28 will be separately discussed below. It can be observed that burner 27 is tilted at a slight angle, with the right side of the burner enclosure slightly higher. This angle provides significant benefits to be discussed in detail later in this disclosure.

The control cavity 25 in FIG. 2 is to the right of the cooking cavity 16, although alternative placements are also possible. For clarity, components that might ordinarily reside in the control cavity 25 are intentionally omitted from the figure. Again, the control cavity 25, while providing a novel and convenient method for the placement of components used for operation of the grill 10, is not essential to the implementation of the invention.

The grill 10 in FIG. 2 is oriented at a tilted angle with a predominantly side view and partial front and top views. The divider 21, control panel 22, control knob 23, and igniter button 24 are readily viewable in this illustration. Hole 26 is used for the igniter (not shown) to feed through to a location proximate to and underneath the burner 27. In this embodiment, the burner 27 is an infrared burner which contains rectangular metal side walls and a metal top cover. The underside of the burner 27 (i.e., that portion of the burner 27 facing down and toward the cooking cavity 16) contains the combustion media. While any suitable type of combustion media can be used in conjunction with the infrared burner, ceramic tiles are utilized in this embodiment. Once ignition of the air and gas mixture originating from the venturi 28 is accomplished as described in greater detail below, radiant heat waves at an infrared wavelength are emitted from the ceramic tiles and into the cooking cavity 16.

While the embodiment of FIG. 2 is being described herein in the context of an infrared burner emitting radiant heat, it will be appreciated that other heat sources may be used without departing from the concepts of the invention. Such other heat sources may include, by way of example, non-gas electrical sources or other suitable heat-emitting devices that would be contemplated by those skilled in the art upon perusal of this disclosure.

Adjacent the burner 27 in FIG. 2 is a top panel 31, which separates the cooking cavity 16 from the above compartment where the burner 27 resides. The lower surface of the combustible media that constitutes part of the burner 27 may in some embodiments be in substantial vertical alignment with the top panel 31. The top panel 31 covers the cooking cavity. The area between the top panel 31 and the burner cover 11 (FIG. 1) is referred to herein as a burner cavity 55. In one embodiment, the burner cover 11 (FIG. 1) and the top panel 31 are turned at substantially the same angle relative to one another. That is, they are substantially parallel, with the exception of the burner 27 itself, which in this embodiment fits into the top wall 31 via a “cut out” for the combustible media.

As can be seen from FIG. 2, the top wall 31 and the burner 27 situated in the burner cutout form are removable but in ordinary operation coupled to the side walls of the grill (FIG. 1) the bottom edges of which are coupled to the bottom wall, directly or through other components.

A portion of a venturi 28 can also be seen. While considered a portion of an infrared generally and for this disclosure, a separate discussion of venture 28 is also provided. The venturi 28 in this implementation is configured to collect a controlled air and gas mixture and thereupon provide the mixture to the burner 27 for use in the combustion process. Although not viewable in FIG. 2, the venturi 28 in one embodiment is attached to one side of the burner enclosure 27. The venturi 28 includes an inlet port 30 through which air from the control cavity 25 is received. Gas is also injected into the venturi 28. To enable the injection of gas, the venturi 28 may also include an orifice 29. The orifice 29 is designed with an appropriate diameter to accommodate a range of possible gas flow rates. The orifice 29 in this embodiment is coupled to a gas source via a tube (not shown) of suitable diameter and thickness in light of the necessary pressure range. Gas may flow into the venturi 28 from a tank typically situated in an area external to the grill 10. The tank in this embodiment is coupled to the orifice 29 on the venturi 28 through the tube. Gas and air (the air through inlet 30, the gas through orifice 29) enter the burner 27 from the outlet of the venturi 28.

Through the combination of the air inlet port 30 and the orifice 29, a mixture of gas and air flows through the venturi 28 and into the attached burner enclosure 27 for use in the combustion process. As an illustration, a user in one embodiment inserts the rack 18 into the cooking cavity 16 at a desired level. After placing the food on the rack, the user turns on the flow of gas to a desired pressure using knob 23. Thereupon, as primary air enters through the venturi inlet 30, gas in this embodiment flows from the tank into the orifice 29. The gas mixes with the air and, as noted above, the combination flows into the input of the burner 27 from the output of the venturi 28. The air and gas mixture proceeds into the burner enclosure 27, substantially sealed but for the combustible media at the bottom of the burner. The combustible media—ceramic tiles in this embodiment—is fit at the bottom of burner 27, and it's heat emitting surface is exposed toward cooking cavity 16, providing a downward heat source. The gas enters the burner enclosure 27, and then it flows throw tiny holes found in and characteristic of ceramic tiles (i.e., the combustion media in this example). The mixture thereby surrounds the igniter which in one embodiment is proximate to and slightly below the combustion media. The user in this embodiment depresses button 24 and ignites the air and gas mixture. Cooking then commences of the food on rack 18 at the heat level chosen via the seating mechanism positioning.

Combustion results at the surface of the combustion media (here, the tiles) as the air and gas mixture continues to flow through the holes in the ceramic tiles. The infrared process creates unique benefits, but its use with the apparatus of the embodiments within the benefits can often be dramatic. Returning to the burner activity, the exploding gas produces the combustion of flames on the ceramic tiles. At a certain heat the cooking process commences. The hot combustible media begins to generate infrared heat rays at extremely high temperatures. The ceramic tiles proceed to emit radiant heat into the protected cooking cavity 16. Among other purposes, the top panel 31 which forms the top surface of the cooking cavity 16 in this embodiment is used to assist in containing the generated radiant heat within the cooking cavity 16. The radiant energy heats and cooks the food.

As noted above, the combustion media need not be restricted to ceramic tiles. The designer of the grill, for instance, may choose to use another type of appropriate combustion media such as metallic mesh, fiberglass panels or the like.

Ordinarily, in the case where infrared radiation is generated, the temperature of the infrared heat rays will range anywhere from approximately 1500 to 1750 degrees Fahrenheit (possibly more). The temperature is primarily a function of the British Thermal Unit (“BTU”) setting of the grill 10. As an illustration of this relationship, the radiant surface in one embodiment may have an average port loading of approximately 300 BTU per hour per square inch of surface area. The infrared heat rays release radiant energy in the wavelength range of approximately two to six microns. The BTU setting in this embodiment is configured for 16,000 BTU/hour. (Of course, these figures are subject to a number of variables and can differ depending on the implementation. As such, the figures are intended to be illustrative approximations rather than restrictive in nature.)

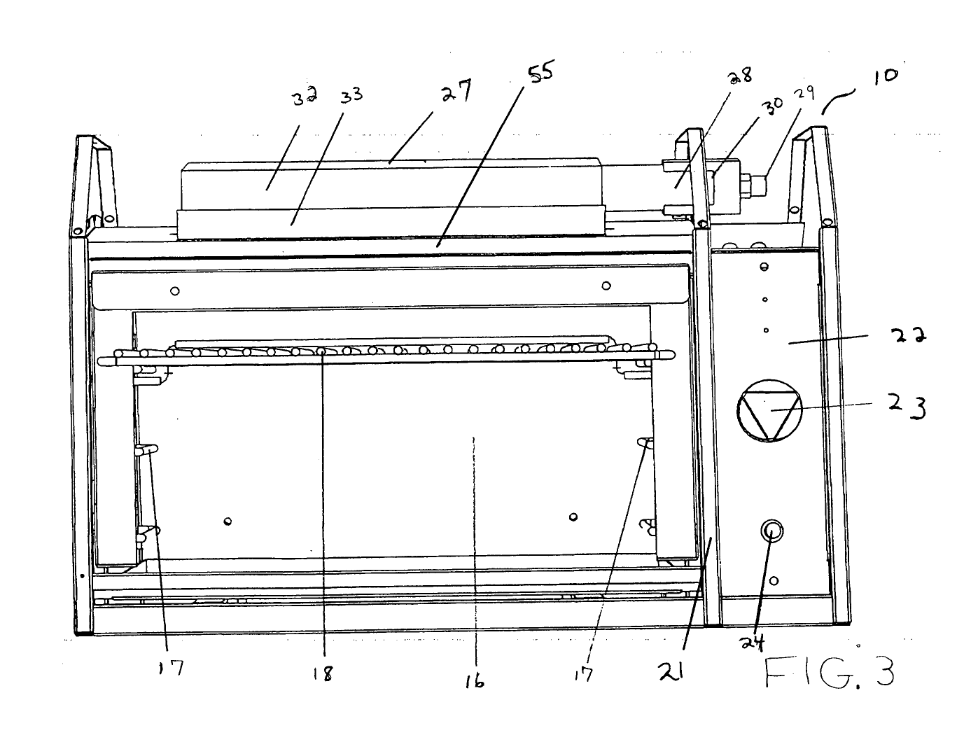

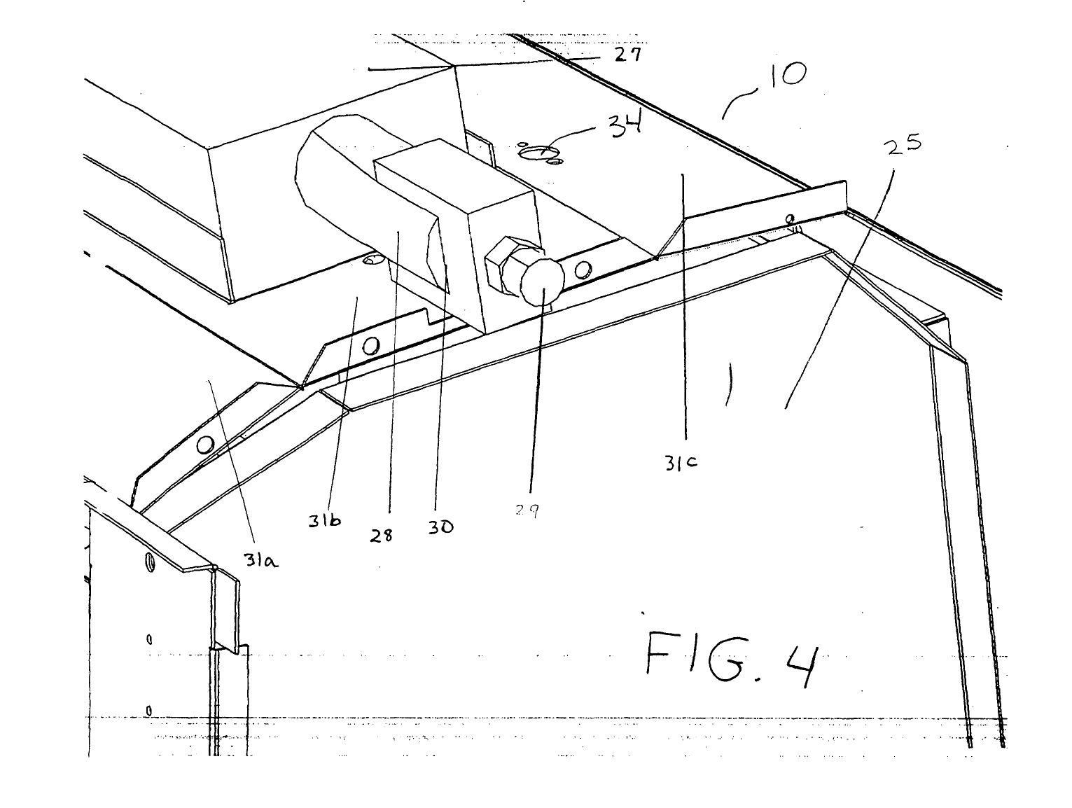

FIG. 3 is a front view of an embodiment of the grill 10 with the top panel 11 and front window removed for illustrative purposes. A side view of the burner 27 is shown with metallic side covers 32 and 33. The cylindrical venturi 28 portion of the burner can also be seen with the inlet port 30 for the injection of primary air, and orifice 29 for the entry of gas through an appropriate connection (not shown). A controlled gas/air mixture is thereby generated in the venturi 28 and proceeds to flow into the burner enclosure 27. As noted above, the flow of the gas into the venturi 29 orifice can be controlled in this embodiment by adjusting knob 23. The end of the igniter (i.e., the point at which the sparks emanate) cannot be seen in this figure (but see FIG. 5, which shows that it is located in that embodiment just below the center of the bottom surface of the burner 27.) The embodiment in FIG. 3 locates a position that will provide optimal combustion within the cooking cavity 16. As described previously, radiant heat generating process uses the igniter (34 in FIG. 5) to ignite the gas/air mixture that flows from venturi 28 outlet portion of the burner 27 into the burner 27 enclosure (characterized by the metal box), and then from the enclosure through the numerous tiny orifices in the ceramic tiles (or other combustible surface used) at the lower surface of burner 27, inducing combustion at the ensuing emission of radiant heat from the surface of the ceramic tiles (50 in FIG. 4).

The shape and size of the venturi 28, inlet port 30, orifice 29, cooking cavity 16, rack 18, and the configuration, width, depth and type of the burner 27 are matters of design choice and may vary widely depending on the implementation. These and other details may be modified significantly from the disclosed embodiments without departing from the claimed invention. As an illustration, it may be desirable in certain circumstances to have reignition capability in the igniter for a particular grill. This type of igniter includes “flame sensing” capability. That is, if the flame is extinguished, the igniter can recognize the termination of the flame and automatically reignite the air/gas mixture. As another example, the orifice 29 may be designed using one of a large number of possible sizes. One factor in determining an optimal diameter of the orifice for a gas-driven grill is the type of gas used. As indicated above, natural gas, liquid propane, butane, and others may be used. The diameter of the orifice represents a design parameter that will typically vary to achieve the desired rate and pressure of gas flow, depending on the type of gas utilized and the properties unique to the gas.

Further, the heat source enclosure can vary significantly in size and shape. The dimensions of the heat source may vary depending upon the application for which the grill 10 will be deployed, as well as the requirements and limitations of various components selected for use in the grill system 10. For instance, where an infrared burner 27 is used, the depth of the burner enclosure may be determined in part by the diameter of the venturi 28. The diameter of the venturi 28, in turn, may be calculated by determining the amount of primary air required to effectuate a clean and safe combustion process. Another important factor in certain embodiments is the primary air to gas ratio, which may be determined by various other calculations or by running tests. The air to gas ratio should be set so that, among other considerations, the flame generated by the combustion process is stable on the combustible medium service of the burner 27—meaning that no excess lifting or flashbacks occur. Another consideration is the generation of flue products. The primary air to gas ratio should be set such that the flame does not generate any flue products at safety levels.

In simpler embodiments, the required surface area of the combustible media (such as the ceramic tiles (see 50 in FIG. 5) used in the embodiments of FIGS. 2 and 3) may be determined by port loading calculations, where the designer knows the required port loading and BTU that the grill will use. In particular,

$$Port Loading ( BTU / ( hour ) ( {in}^{2} ) ) = \frac{BTU setting ( BTU / hour )}{Media ( {in}^{2} )}$$

Consequently, if the designer has determined the appropriate port loading characteristics and BTU setting for the device, she can ascertain the required surface area for the ceramic tiles to be used in grill 10.

The seating mechanism 17 in the embodiment of FIG. 3 enables the user to place the rack 18 in three discrete positions relative to the burner 27. The user can therefore vary the amount of exposure of the food by discrete amounts. These embodiments effectively allow the user to adjust the temperature without having to adjust the infrared burner itself. In some embodiments, the seating mechanism 17 constitutes a set of wire racks that form shelves. In still others, the seating mechanism is implanted via indentations or grooves in the cooking cavity 16 itself. The shelves can be inserted into the grill 10 and removed when not needed. Removal may be used to make more space available for food items that are large relative to the grill 10. Removal, when appropriate under the circumstances, further obviates the need for cleaning the seating mechanism 17.

This feature is in contrast to traditional grills having a single level. The sole option to vary the cooking temperature on such grills is to change the gas pressure. Adjusting this parameter in a gas burner often results in unpredictable and potentially wider than desired variances in temperature. Infrared burners can exhibit even more severe nonlinear operating characteristics when downward temperature adjustments are made. This common problem with traditional gas grills can reduce the quality of the cooked food.

While the seating mechanism 17 in FIG. 3 shows three levels in the cooking cavity 16 upon which the rack can be placed, the number can be lower or higher depending on various factors like the available volume of the cooking cavity 16, the need for diversifying the cooking rates in the grill, and other considerations.

Referring now to FIG. 4, a close up and angled view of an embodiment of the grill 10 is shown. For ease of illustration, the wall 13 from FIG. 1 used to form part of the control cavity has been removed. FIG. 4 provides a “zoomed in” view of the venturi 28. The orifice 29 for the injection of the gas and the inlet port 30 for the entry of the primary air can be seen. The cooking cavity is blocked from view in this embodiment. As the embodiment of FIG. 4 demonstrates, the burner 27 does not run the entire length of the cooking cavity. The embodiment of FIG. 4 also shows that the top panel 31 (FIG. 1) is divided into three metal segments, 31a, 31b and 31c. (The division of the segments is for purposes of illustration; in some embodiments the top panel 31 may constitute a single sheet of material shaped into the three segments.) The center segment 31b is configured to accommodate the burner 27. As such, the surface of the center segment 31b facing the cooking cavity includes the surface of the ceramic tiles. The segment 31b may be cut to incorporate insertion of the burner. In one embodiment, the top wall 31 is built by a single metallic sheet bent to form the necessary segments.

The position of the infrared burner 27 in FIG. 4 emphasizes a benefit briefly discussed above. The position is such that the primary air inlet 30 to the venturi 28 and the orifice 29 extend outside of the area above the cooking cavity 16 and into the control cavity to the right of divider 21. As noted, this arrangement prevents flue products generated in the cooking cavity 16 as a result of the cooking process from recirculating back into the venturi 28. This positioning of the components consequently avoids the problem of progressively poorer emission. Further, the arrangement in this embodiment ensures that the temperature of the venturi 28, inlet 30 and orifice 29 remains cool relative to the cooking cavity 16. As such, flashback at the inlet 30 is avoided.

FIG. 5 is a side view of an embodiment of the grill 10. As in earlier figures, FIG. 5 is not drawn precisely to scale in order to demonstrate more clearly the operation of the grill 10. The angled burner cover shown in FIG. 1, a side wall facing the viewer, and the window on the door have been removed for viewing purposes. The dripping pan 40 in this embodiment rolls in and out of the grill 10 by rails 51. The seating mechanism 17 provides three levels for placement of the rack 18. The seating mechanism 17 constitutes metal bars in this embodiment for securing the rack 18; however more or less bars may be used depending on the available space and other factors. In this embodiment, the seating mechanism 17 can either be removable or can be affixed to the interior of the cooking cavity 16. The surface of the ceramic tiles 50 facing the cooking cavity 16 can also be seen in this embodiment. The surface 50 is part of the burner 27.

In addition, the unique view of the grill 10 as oriented in FIG. 5 is particularly suitable for demonstrating still another embodiment. As in certain other embodiments, the grill 10 comprises a cooking cavity with four side walls. Again, the side wall facing the viewer is omitted for clarity and ease of illustration. Assume, for purposes of this illustration, that the burner 27 is an infrared burner and that the burner surface 50 uses ceramic tiles 30 for the combustion media. (As in other embodiments, these assumptions immediately above are merely for exemplary purposes and other appropriate heat sources and cooking media may be equally applicable). Wall 219 constitutes a portion of the top wall. Thus, along with wall 219, walls 55a, 55b, and ceramic surface 50 represent the top wall of the cooking cavity 16.

Continuing with a description of this embodiment, it is easily seen, as in other embodiments, that various portions of the top walls are not horizontal in nature. Rather, they are configured to tilt in various angles. For example, consistent with earlier embodiments but easier viewed is top wall portion 55a, which is configured at an angle. The wall portion 55a moves downward from the infrared burner mechanism's adjacent joining point denoted 55.

As can be seen, the burner 27 and the combustible media 50 are tilted at an angle, e.g., at a seven degree angle (or other appropriate angle in light of the particular configuration of the top wall and burner at issue). The point 50b is elevated slightly with respect to 50a. Thus, the front edge of the burner 27 is slightly below the back edge of the burner. The angled configuration of the burner 27 assists in keeping flue products generated from the infrared combustion process flow easily towards the rear of the burner cavity 55 and cooking cavity 16. The rear portion of the top wall segment 219 provides a series of vents 215, in the form of a series of slits parallel to another in the illustrated embodiment. Essentially, the tilting arrangement of burner 27, in combination with the principle that heat tends to rise, promotes the flow of flue products to the rear of the grill 10, away from the user (operating the grill 10 from the access panel), and through the vents 215 in top panel 219 at the rear of the unit. In effect, a “chimney” effect is created that generates an effective flow pattern for the flue products to exit away from the user. The size of the slits 215 in the top rear wall 219 depend on the amount of flue products generated in a given application. Furthermore, the top wall segment 55a is angled downward to minimize the exposure of the user to heat from the grill 10 when the front door is opened. The downward angle of top wall panel 55a helps protect the user from exposure to the potentially extreme heat in the grill 10. The heat is essentially maintained in the interior of the grill, with unwanted by-products moving away from the user through vents (or slits) 215.

Likewise, the upward angled top panel 55b in FIG. 5 is designed in accordance with the principle of heat rising. The upward angle assists in eliminating obstructions to the flow of flue products through vents 215. This function of panel 55b assists angled ceramic tiles 50 to maintain heat away from the user by directing the radiant heat slightly inward (due to the angled ceramic tiles 50) and by providing a clear path for the exit of by-products through vents 215, and out of the grill 10 in a direction away from the user.

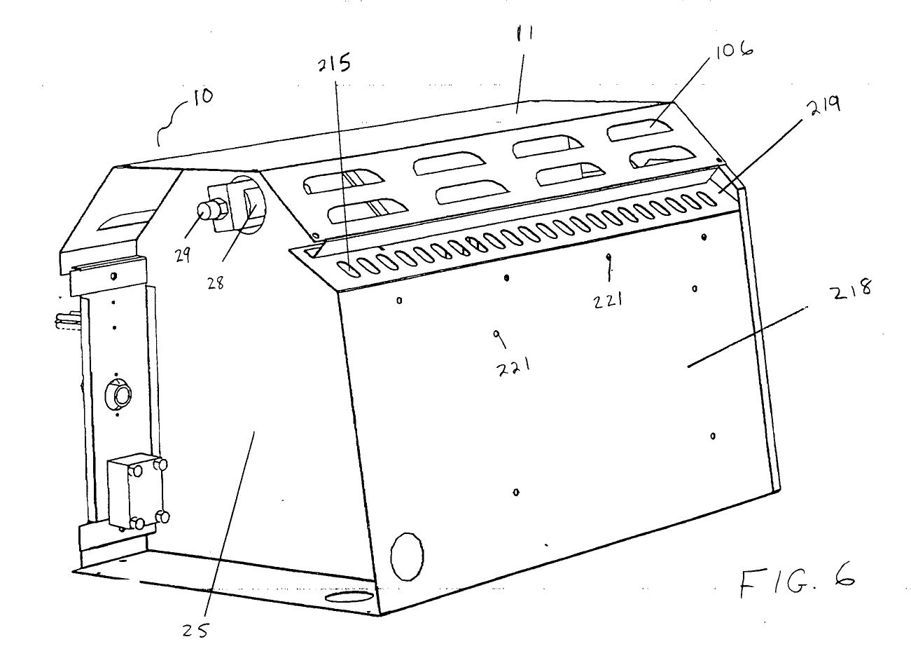

Referring now to FIG. 6, a drawing illustrating the rear of the grill 10 according to an embodiment implementing the rear vents 215 is shown. The grill 10 includes the burner cover 11 forming a protective boundary from the heat of the burner 27 (FIG. 5), angled top wall (mostly obscured in FIG. 6 by burner cover 11 but shown in FIG. 5), the control cavity 25, the venturi 28 along with the gas inlet orifice 29 extending into the control cavity 25. A wall and various components of the control cavity are not shown here. Rear wall 218 represents the rear of the grill 10. The rear portion of the top wall, 219, is not covered by burner cover 11 to allow the smooth flow of flue products or other by products to exit out the rear and away from the user. The user is ordinarily located in the front of grill 10, where the door and window provides access to the cooking cavity 16 and to the control knobs (23 in FIG. 2) and igniter button (24 in FIG. 2), or other control mechanisms reside in many embodiments. Vents 106 (similar in function and purpose to vents 12 in FIG. 1) provide an outlet for the transfer of heat from the burner cavity (that is, the area from the burner wall to the top wall and burner) and can cool the burner cavity and can also, for example, maintain the walls and interior within safety requirements.

FIG. 6 provides a clearer view of the rear portion of top wall 219 and the corresponding set of vents 215 out of which flue products may be emitted. In other embodiments, vents 15 may vary in size and shape and may be situated in another appropriate manner that effectively provides for the flow of much of the flue products out of the rear of the unit.

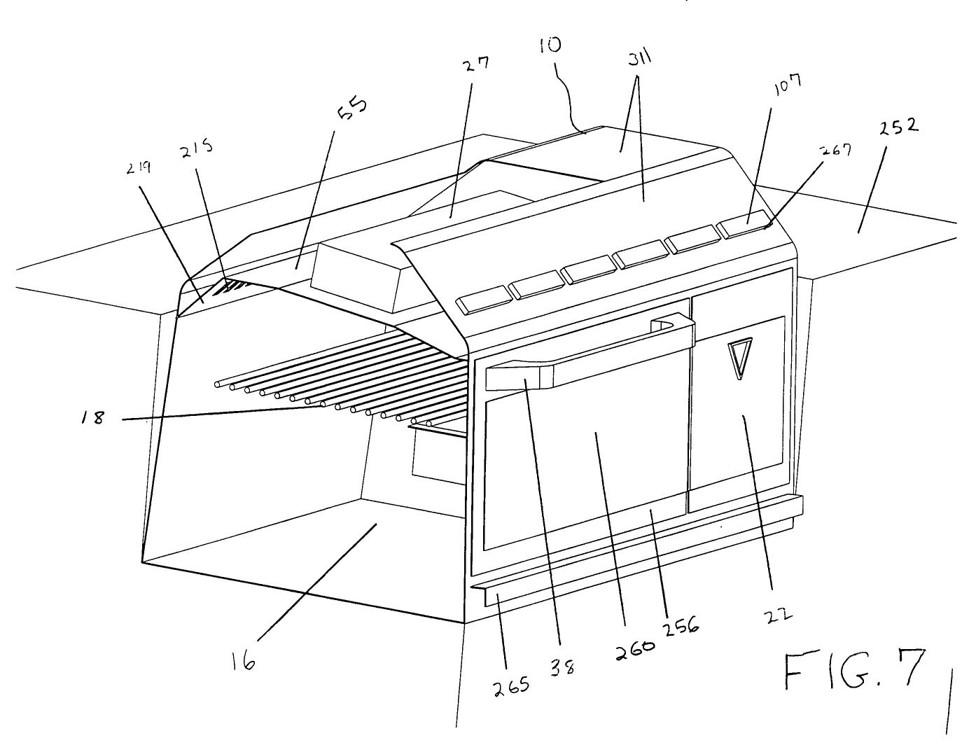

FIG. 7 is an angled view of an embodiment of the grill configured as part of an island with a side wall cut away to show the cooking cavity 16. While not shown, the venturi 28 extends into control cavity (25 in FIG. 2). Portions of the various segments of top wall 55 can be seen, as well as a portion of top wall 219 containing vents 215 for the emission of flue products as explained in connection with FIGS. 5 and 6. A side wall on the left side of grill 10 relative to the front is omitted for ease of viewing. The rack 18 is situated in the cooking cavity 16. The components 107 (identical in function to vents 12 in FIG. 1, with six in this embodiment) represent vents that control the flow of heat to maintain safety levels. Cool fresh air from the environment enters these vents 107 to cool the burner 27. While being heated by the burner in operation, the air then exit the opening vents 215 in the rear. On an exemplary louver 107, the opening is at the bottom wall 267 where air enters into the cavity 55 (seen in FIG. 3). A door handle 38 provides for opening of the front door 256 which in this embodiment is manufactured with metal casing. A large window opening 260 enables the user to view the food and monitor the progress of the grilling process. The grill 10 may also contain a light switch (not shown) as well as a suitable lighting mechanism inside cooking cavity 16. Cover 22 is the cover panel that provides user access to the control cavity (not seen but behind the cover panel 22). Handle 265 represents the handle of a dripping pan (such as pan 40 in FIG. 5) used to collect grease, etc. Using the handle 265, the dripping pan (interior to the grill 10 and not viewable) can be removed, cleaned and inserted easily.

FIG. 7 also shows an example of one of many possible configurations of the grill 10. In FIG. 7, the grill 10 is constructed a component of an island 252 which may contain a comprehensive set of other outdoor products such as faucet, sink, warming drawer, etc.

FIG. 7 illustrates that the specific configuration of many of the components of the grill 10, from the shape of the door handle 38 to the configuration of the top cover 311, and the number and type of vents are design choices that may change depending on the implementation of the grill and are not essential to the invention. In addition, depending on the grill, details such as the configuration and composition of the side walls and other components, including the size shape and method of attachment to one another or to the top and bottom of the grill, and others, are further examples of details that often vary depending on the grill. These details however, likewise are design choices that do not depart from the present invention. In addition, some embodiments do not use a control cavity, which, while a desirable and novel feature, is not required to fall within the scope of the invention.

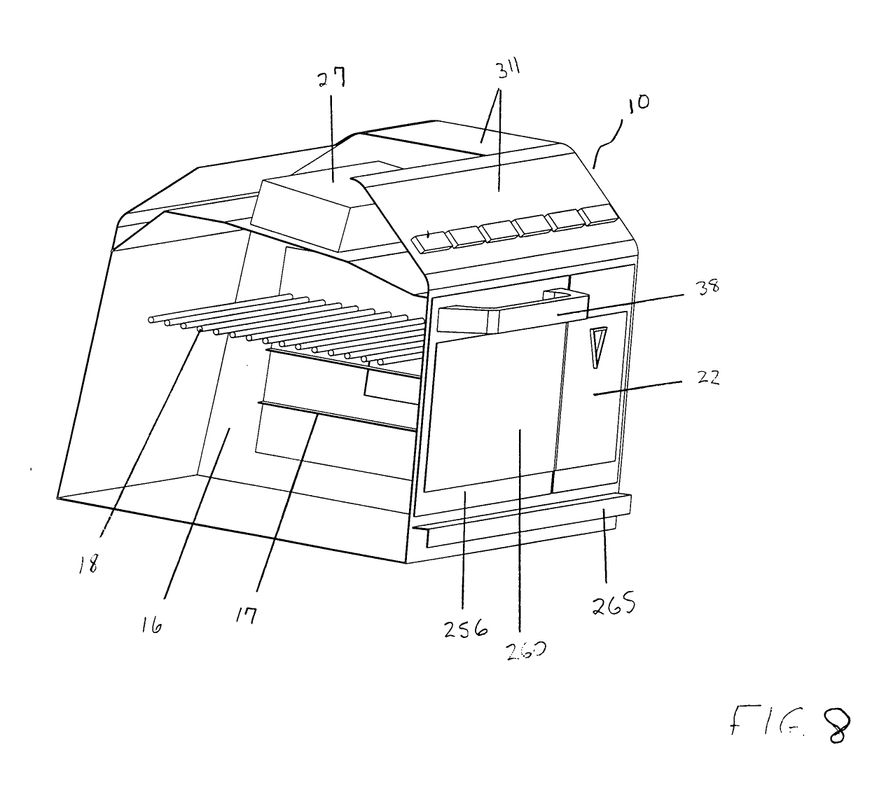

FIG. 8 shows a drawing of the embodiment of the grill in FIG. 7. Among other components, the grill 10 includes the cover 311, front door 256, burner 27, handle 265, rack 18, control panel 22, among others. In addition, the seating mechanism 17 can be seen on one of the side wall. The major difference between FIGS. 8 and 7 is that FIG. 7 is not integrated with an island. Rather, it is a stand-alone device. In some embodiments, a cart with wheels may be added to the bottom of grill 10 for mobility, such as in outdoor residential settings.

In still another embodiment, the grill 10 may be implement as a rotisserie grill in lieu of a rack with a seating mechanism. For example, a spit may be located in the cooking cavity with each end on the narrower side walls of the grill. A mechanism for rotating the spit (well known in the art) would be included to rotate the spit, and in turn, the food content secured on the spit. This configuration retains the significant advantages of the embodiments disclosed above while allowing the user to cook food using the rotisserie option. The rotating mechanism, such as a rotating motor, along with its control components, and wiring, may be very well be placed inside the control cavity 25, with its on/off button accessible on the control panel 22.

The grill disclosed through the exemplary set of embodiments herein provides significant advantages over existing implementations. A partial list of some of these advantages will be described in the ensuing paragraph. (Numerous other benefits will be apparent to those skilled in the art upon perusal of this disclosure.) These benefits solve the shortcomings in existing configurations and address the illustrative disadvantages of traditional grills discussed earlier and, where appropriate for clarity, are referenced in more detail below.

The heat source in the embodiments herein is mounted above the food content in a cooking cavity. This orientation of the heat source over the cooking cavity as disclosed above is significant for many reasons. For one, juice, grease, and other food drippings generated from the cooking process are collected below, such as in a dripping pan or other surface. Because the burner is configured at the top of the cavity, these drippings are highly unlikely to ignite. This configuration is superior to grills having the heat source configured below the cooking area, where drippings commonly result in unwanted flare-ups when the grease catches on fire. Many of these grills employ no protective cavity, exposing the user to a potentially dangerous condition. A large amount of flame can result, which is not only hazardous but can also adversely affect the cooking process when the unwanted flames sear the food item. The cooking cavity disclosed herein, by contrast, provides user protection from drippings even in the highly unlikely event of spurious flames resulting for any reason. As such, the positioning of the burner in the cooking cavity produces less or no flare ups, and protects the user from the heat. Cleaning is easier since the user can simply clean the bottom of the grill surface, or in some embodiments, the user can simply remove a dripping pan for cleaning and then simply reinsert the pan into the grill.

Further, the heat source and cooking cavity described herein provided significant benefits over the many outdoor grills that mount the heat source—such as an infrared burner—below the food content, including for searing purposes. This traditional arrangement invariably clogs up the burner itself. The severity of the clogging only progresses as the grill use continues. Juice, grease, and other drippings fall and cover the infrared burner upper surface, where the cooking flame otherwise resides. The drippings eventually fall into other parts of the burner. Among other problems with this traditional arrangement, the clogging will eventually dramatically affect—for the worse—the flame characteristics of the infrared burner. Port loading is adversely effected and changes unpredictably. Emission worsens. Heating characteristics are effected, often unpredictably so. The result is undesirable emission characteristics during the cooking process, and uneven hot spots. Hot spots can be produced by portions of the infrared burner being significantly more clogged than other portions. Thus, heat radiated from the less-clogged portions is more powerful, while heat radiated from the more-clogged emissions is less powerful or even clogged to the point where those portions of the burner are rendered inoperable for all practical purposes. In effect, upon continued use of the grill, the user looses control over the cooking process. The heat source amounted at the top of the cavity 16 in the above embodiments of this disclosure eliminates this problem. Further, the life of the heat source is likely to be much greater because the source is exposed to much less unwanted by-products of grilling.

The benefits of the embodiments herein apply equally to the situation where the cooking cavity of the grill in this disclosure is configured with a rotisserie in the cooking cavity. The rotisserie method is in lieu of a rack arrangement, as noted above. Rotisserie arrangements, which cook food on a rotating rod or spit, are used in some situations because they provide some different cooking characteristics that may occasionally be desired for certain cooking applications, These characteristics depend on a wide variety of well-known circumstances not pertinent to this disclosure. (As noted, the use of a rotisserie is known in the art and the details and properties consequently need not be discussed at length here, except as mentioned above in the illustration of the positioning of the spit in the cooking cavity).

In the existing rotisserie arrangements of which the inventors are aware, an infrared burner is mounted vertically at the rear of the grill. The burner is located above the grilling surface and behind the food on the spit. The combustible surface of the burner faces forward to provide radiant heat towards the rotating food on the spit. This traditional arrangement, unfortunately, has problems, not the least of which is the fact that the opened and intensely hot infrared flame is exposed forward and directly towards the user. High temperatures and flue products can easily contact the user standing in front of the grill or tending to the rotating food. Obviously, this prior implementation can be unsafe and result in injury. Further, any delayed ignition of the burner may cause a burst of flame to move in the user's direction, producing a potential fire hazard and creating an unfortunate condition for a person at the front of the grill.

By contrast, the embodiments disclosed herein have the heat source (e.g., infrared burner) mounted above the food and away from the user. The radiant heat from the burner is directed downward at the rotisserie, rather than at the user. Thus, unpredictable flames or flue products move in a direction away from the user, even when the user has opened the door of the grill. The cooking cavity provides comprehensive protection from unpredictable or unexpected occurrences of flame. Further, the unique and calculated orientation of the angles of the top wall and burner surface, as in the embodiments shown in FIGS. 6 and 7, provide further protection to promote the flow of heat and flue products in a direction away from the front of the grill. The safety problems with the rotisserie prior art mechanism are effectively eliminated.

Another advantage of the embodiments herein is that the mounting of the heat source above the food can substantially enhance the flavor of the resulting cooked food item. More specifically, the mounting of the burner above the food content on the rack generates juice on the surface of the food. Rather than the juice flowing down and away from the food, the juice remains within, and is effectively sealed inside, the food. The flavor differences in the end product can be significant.

As noted above, traditional grills with heat sources (e.g., infrared burners or regular tubular burners) located below the rack containing the food, the heat source will likewise generate juice from the food product. Unfortunately, the juice is generated on the bottom, rather than top, surface of the food. Rather than being absorbed and maintained in the food, the generated juice simply drips out of the bottom of the food. The resulting cooked food item, being deprived of flavor-enhancing juices, can be too dry and inferior in taste.

The multiple shelf arrangement discussed in connection with various embodiments allows the user to adjust the cooking temperature as deemed appropriate by doing nothing more than lowering and raising the food on the rack. The seating mechanism may provide multiple levels for the rack in these embodiments, making the process of changing the rack level straightforward. The use of the seating mechanism accommodating multiple levels to situate the rack at different temperatures obviates the need to adjust the infrared burner itself, which can result in problems alluded to earlier. Specifically, most infrared burners are designed with particular and often precise settings that help ensure optimal temperature settings and predictable well adjusted radiant heat properties. Because traditional grills lacking multiple levels require the modification of these settings where temperature adjustment is desired (e.g., by turning down the burner), a problem results when the burner is adjusted above or below its articulated design parameters—a frequent occurrence. The result (as noted above), is unpredictable heat and temperature characteristics that may vary widely from the desired adjustment, operational problems of the burner, or failure of the burner altogether. Likewise, modification of the temperature can create unstable flame characteristics, including for example, blow off, flashback, or distinction. The embodiments herein solve this problem since temperature adjustment may be accomplished without modifying the burner temperature.

The top mounted heat source provides numerous other benefits, many of which will be apparent to those skilled in the art upon review of the present disclosure. The benefits can be subtle yet highly useful for the user. For example, the top mounted heat source can be used for cheesemelting purposes. The retention of heat within a cooking cavity results in a safer grill. The retained heat maintains efficiency during the cooking process and can enhance the cooking process itself by maintaining a relatively constant heat level around the food item. A fan can also be situated in the cooking cavity to ensure even distribution of the heat and hence, even, controlled grilling. Further, where desired, alternative heat sources may be deployed, such as a tubular burner. The cooking cavity keeps the heat away from sensitive grill components, such as those contained in the control cavity in the embodiments disclosed herein. Also, the angled orientation of the top surface, as earlier noted, helps prevent the emission of heat at the user when she opens the door, resulting in a more comfortable cooking process. The size, shape and orientation of the cooking cavity, burner, and other components can be selected to suit the intended application.

Further, the enclosed cooking cavity the present embodiments retains the high temperatures and instead produces small and controlled amounts of heat emission from known louvers or vents, the grill as disclosed herein can be optimal for attachment above a refrigerator unit, such as in a residential outdoor application. The refrigerator unit may be configured below the grill, for example, and may contain items like barbecue sauce, and the food items to be cooked. Side panels or drawers can be added for utensils, towels, seasonings and the like. In addition to rotisserie and fan, a mechanism capable of spraying steam can also be incorporated into the grill, inside the control cavity. By spraying heated steam/vapor into the cooking cavity, the grill can now function as a steamer, in addition to broiling, searing, and baking. The spraying process can easily be accomplished with a spray nozzle design and water source. The possibilities of the novel grill herein are limited only by the imagination.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A grill comprising:
a cooking cavity comprising a top wall, a plurality of side walls, and a bottom floor, one of the side walls comprising an access door, the top wall comprising a radiant heat source for emitting radiant heat downward toward the bottom floor;
a rack configured for placement in the cooking cavity; and
an igniter configured to provide ignition for the radiant heat source.

2. The grill of claim 1 wherein the radiant heat source comprises an infrared burner.

3. The grill of claim 1 wherein the cooking cavity comprises a fan coupled to a wall.

4. The grill of claim 1 wherein the radiant heat source is angled, the upper side of the angled heat source facing a side wall of the plurality that is opposite the side wall comprising the access door.

5. The grill of claim 4 wherein the top wall comprises a segment comprising a plurality of vents, the top wall segment located proximate to the side wall opposite the side wall comprising the access door.

6. The grill of claim 1 further comprising a control cavity adjacent the cooking cavity, the radiant heat source comprising a venturi comprising an inlet for gas, the venturi inlet extending into the control cavity.

7. The grill of claim 1 further comprising a seating mechanism comprising a plurality of sets of ledges, each set configured to seat the rack.

8. A grill comprising:
cavity means for placing a food on a rack supported by seating means in the cavity; the cavity means further comprising:
access means for inserting and removing food within the cavity, the access means configured to allow access to the cavity; and
means for providing radiant energy for emission downward toward the rack for cooking the food item.

9. The grill/of claim 8 further comprising control cavity means adjacent the cavity means for enclosing electrical and mechanical components for use with the grill.

10. The grill of claim 8 further comprising a dripping pan adjacent the bottom floor.

11. A grill comprising:
a cavity comprising an enclosure, the enclosure comprising a plurality of side walls, each side wall of the plurality comprising two side edges, each side edge coupled to another side edge to form the enclosure, one side wall of the plurality comprising an access door, and each side wall of the plurality comprising a top edge and a bottom edge;
a top wall coupled to the top edges of the enclosure, and a bottom wall coupled to the bottom edges of the enclosure, wherein the top wall comprises an infrared burner comprising a combustible surface configured to emit heat downward toward the floor;
a rack configured for placement in the cavity; and
an igniter configured to provide ignition to the combustible surface.
